(19) United States
(12) Patent Application Publication
(10) Pub. No.: US 2017/0122761 A1
(43) Pub. Date: May 4, 2017

(54) METHOD, DEVICE AND NAVIGATOR FOR RESCUING VEHICLES

(71) Applicant: Leauto Intelligent Technology (BEIJING) Co. Ltd., Beijing (CN)

(72) Inventors: Wei LIN, Beijing (CN); Yu ZOU, Beijing (CN); Yong XU, Beijing (CN); WenRui LI, Beijing (CN); KunSheng CHEN, Beijing (CN); Dan LI, Beijing (CN); Peng LIU, Beijing (CN); XiaoFei GOU, Beijing (CN)

(21) Appl. No.: 14/978,554

(22) Filed: Dec. 22, 2015

(30) Foreign Application Priority Data
Nov. 2, 2015 (CN) 201510733886.5

(51) Int. Cl. G01C 21/36

(52) U.S. Cl. CPC G01C 21/362; G01C 21/3667; G01C 21/3632

(57) ABSTRACT

A method, device, and navigator for rescuing vehicles are disclosed. It is possible to enable the nearby vehicles to provide rescuing in time, improve the efficiency of rescuing and the vehicles to be rescued may acknowledge the positions of the rescuing vehicles by acquiring the rescuing information input by a user on the interface displaying a map, and then generating a rescuing request carrying the rescuing information and further broadcasting the rescuing request via V2X communication and displaying the position of the rescuing vehicle in the map when the rescuing response is received.

### CROSS-REFERENCE TO RELATED APPLICATIONS

This application is based on and claims priority to Chinese Patent Application No. 201510733886.5, with the title of “METHOD, DEVICE AND NAVIGATOR FOR RESCUING VEHICLES”, filed on Nov. 2, 2015, the full disclosure of which is hereby incorporated by reference in its entirety.

### TECHNICAL FIELD

The present disclosure relates to electronic technologies, and particularly to a method, a device, and a navigator for rescuing vehicles.

### BACKGROUND

During the driving of vehicles, if there are faults happening in vehicles, in the related art, it is common that the driver calls a rescue telephone number with a mobile phone or issues a rescuing need via a rescuing network platform, and then waits for rescuing people and rescuing vehicles to make rescuing.

However, the inventors find that the methods in related art have at least the following problems: regarding the manner of using a mobile phone to call the rescuing telephone number or using the rescuing network platform, it often happens that when the vehicle with a fault is in a remote region, the rescuing actions may not be in time, due to the fact that the rescuing sites are relatively separated.

Therefore, in the prior art, it may be low efficient to use a mobile phone to call the rescuing telephone number or use the rescuing network platform.

### SUMMARY

The embodiments of the present disclosure provide a method, a device, and a navigator for rescuing vehicles to improve the rescuing efficiency for rescuing vehicles.

In the first aspect, there is provided a method for rescuing vehicles including: acquiring rescuing information for requesting a rescuing for a first vehicle input on an interface displaying a map by a user; wherein, in the map, icons of respective vehicles is displayed according to the positions of respective vehicles; generating a rescuing request including a position of the first vehicle and the rescuing information; broadcasting the rescuing request via a V2X (Vehicle to X) communication; erasing the icons of respective vehicles displayed in the map and displaying the icons of the first vehicle according to the position of the first vehicle in the map, and displaying the icons of the second vehicle according to the position of a second vehicle in the map, if a rescuing response transmitted by the second vehicle is received.

In the second aspect, there is provided a method for rescuing vehicles including: displaying icons of respective vehicles in the map according to positions of respective vehicles; changing colors of the icons of the first vehicle corresponding to the first vehicle in the map when a rescuing request transmitted by the first vehicle is received.

In the third aspect, there is provided a device for rescuing vehicles including: an inputting module configured to acquire rescuing information for requesting a rescuing for a first vehicle input on an interface displaying a map by a user; wherein, in the map, icons of respective vehicles is displayed according to the positions of respective vehicles; a generating module configured to generate a rescuing request including a position of the first vehicle and the rescuing information; a broadcasting module configured to broadcast the rescuing request via a V2X (Vehicle to X) communication; a displaying module configured to erase the icons of respective vehicles displayed in the map with the on-vehicle device, and display the icons of the first vehicle according to the position of the first vehicle in the map, and display the icons of the second vehicle according to the position of a second vehicle in the map, if a rescuing response transmitted by the second vehicle is received.

In the fourth aspect, there is provided a device for rescuing vehicles applied to a vehicle, the device including: a displaying module configured to display icons of respective vehicles in the map according to a positions of respective vehicles; a changing module configured to change colors of the icons of the first vehicle corresponding to the first vehicle in the map when a rescuing request transmitted by the first vehicle is received.

In the fifth aspect, there is provided a device for rescuing vehicle, comprising: one or more processors; a memory; and one or more programs stored in the memory and configured to perform operations when executed by the one or more processors, wherein the operations comprise: acquiring rescuing information for requesting a rescuing for a first vehicle input on an interface displaying a map by a user, wherein, in the map, icons of respective vehicles are displayed according to positions of respective vehicles; generating a rescuing request, the rescuing request comprising a position of the first vehicle and the rescuing information; broadcasting the rescuing request via V2X (Vehicle to X) communication; and erasing icons of respective vehicles displayed in the map and displaying the icons of the first vehicle according to the position of the first vehicle in the map, and displaying the icons of the second vehicle according to the position of a second vehicle in the map, if a rescuing response transmitted by the second vehicle is received.

In the sixth aspect, there is provided a device for rescuing vehicles, which is applied to a vehicle, the device comprising: one or more processors; a memory; and one or more programs stored in the memory and configured to perform operations when executed by the one or more processors, wherein the operations comprise: displaying icons of respective vehicles in the map according to positions of respective vehicles; changing colors of the icons of the first vehicle corresponding to the first vehicle in the map when a rescuing request transmitted by the first vehicle is received.

In the seventh aspect, there is provided a navigator including the device for rescuing vehicles provided by the third aspect and the device for rescuing vehicles provided by the fourth aspect.

According to the method, device, and navigator for rescuing vehicles, it is possible to enable the nearby vehicles to provide rescuing in time, improve the efficiency of rescuing and the vehicles to be rescued may acknowledge the positions of the rescuing vehicles by acquiring the rescuing information input by a user on the interface displaying a map, and then generating a rescuing request carrying the rescuing information and further broadcasting the rescuing request via V2X communication and displaying the position of the rescuing vehicle in the map when the rescuing response is received.

### BRIEF DESCRIPTION OF THE DRAWINGS

FIG. 1 is a flowchart of a method for rescuing vehicles provided by the first embodiment of the present disclosure;

FIG. 2 is a flowchart of another method for rescuing vehicles provided by the second embodiment of the present disclosure;

FIG. 3 is a structural view of a device for rescuing vehicles provided by the third embodiment of the present disclosure;

FIG. 4 is a structural view of another device for rescuing vehicles provided by the fourth embodiment of the present disclosure;

FIG. 5 is a structural view of still another device for rescuing vehicles provided by the third embodiment of the present disclosure; and

FIG. 6 is a structural view of a device for rescuing vehicles provided by the present disclosure.

### DETAILED DESCRIPTION

Detailed description is given below for the method, device, and navigator for rescuing vehicles provided by the embodiments of the present disclosure in connection with the drawings.

### First Embodiment

FIG. 1 is a flowchart of a method for rescuing vehicles provided by the first embodiment of the present disclosure. The method provided by the embodiment of the present disclosure may be performed by an on-vehicle device, which may be a navigator, and may be mounted on the first vehicle mentioned in the present embodiment. As shown in FIG. 1, the method may include:

Step 101: acquiring rescuing information for requesting a rescuing for a first vehicle input on an interface displaying a map by a user. In the map, icons of respective vehicles are displayed according to the positions of respective vehicles.

More particularly, a driver, as a user, may visibly acknowledge the positions of nearby vehicles by receiving positions of respective vehicles broadcast by each vehicle via V2X communication and displaying icons of respective vehicles at the positions of respective vehicles in the map. This is because the V2X communication is a kind of short-range communication, and thus based on the positions of vehicles, particularly the positions of nearby vehicles, received via V2X communication, and icons of vehicles displayed in the map, the driver may acknowledge positions of nearby vehicles even in a region with a narrow visual field, and the safety in driving may be improved. Meanwhile, a rescuing button may be provided on the interface displaying the map, and when the rescuing button is pressed by the user, rescuing information may be input on the interface. The rescuing information may include one or more of model of vehicle, plate number, name of owner of the vehicle, description on fault, reward, and emergency level of rescuing action, and combinations thereof. For example, the rescuing information may include the number of people to be rescued, fault of vehicle to be rescued, health conditions of people to be rescued, supplies demands, personnel demands, technique demands, service demands, rescuing level, notes, and the like. More particularly, the more emergent the rescuing situation is, the higher the rescuing level is.

Step 102: generating a rescuing request carrying the rescuing information. More particularly, the on-vehicle device may generate the rescuing request according to the position where the first vehicle with the on-vehicle device thereon is located and the input rescuing information. That is to say, the rescuing request may include a position of the first vehicle and the rescuing information.

Step 103: broadcasting the rescuing request via V2X (Vehicle to X) communication. More particularly, the on-vehicle device may continuously broadcasting the rescuing request based on V2X communication, until a rescuing response transmitted by a second vehicle is received. As a possible implementation, frequency for the on-vehicle device to broadcast the rescuing request may change according to the rescuing level in the rescuing information. That is to say, the higher the rescuing level is, the frequency for broadcasting the rescuing request is higher. The frequency for broadcasting the rescuing request may be in a range of 0.1 Hz to 1 Hz.

Step 104: erasing the icons of respective vehicles displayed in the map and displaying the icons of the first vehicle according to the position of the first vehicle in the map, and displaying the icons of the second vehicle according to the position of a second vehicle in the map, if a rescuing response transmitted by the second vehicle is received. More particularly, when the rescuing response is received, the on-vehicle device may not display the icons of respective vehicles in the map any longer, but only display the icons of the first vehicle and the icons of the second vehicle.

According to the embodiments of the present disclosure, it is possible to enable the nearby vehicles to provide rescuing in time, improve the efficiency of rescuing and the vehicles to be rescued may acknowledge the positions of the rescuing vehicles by acquiring the rescuing information input by a user on the interface displaying a map, and then generating a rescuing request carrying the rescuing information and further broadcasting the rescuing request via V2X communication and displaying the position of the rescuing vehicle in the map when the rescuing response is received.

### Second Embodiment

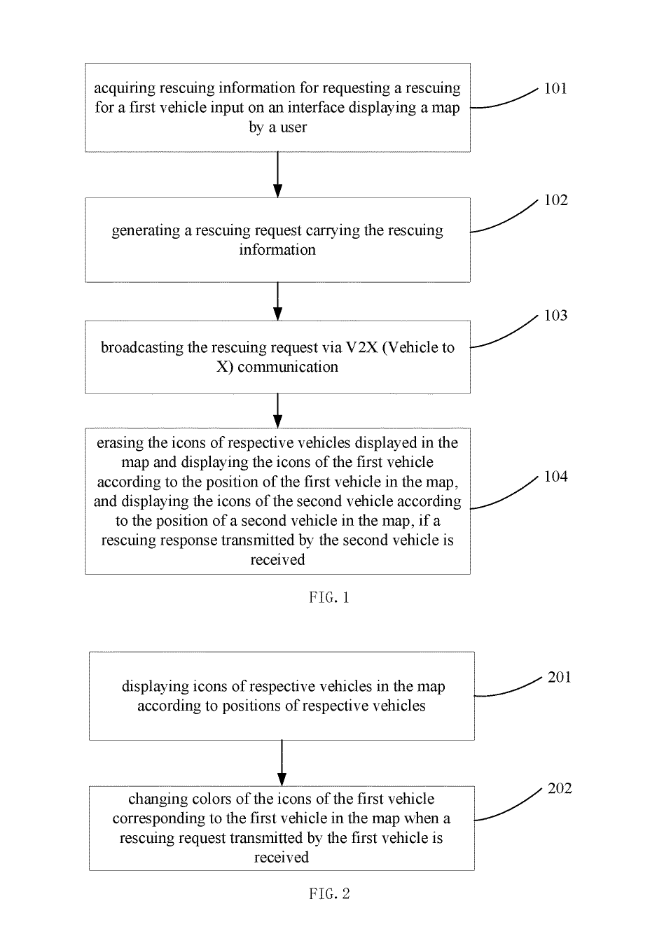

FIG. 2 is a flowchart of another method for rescuing vehicles provided by the second embodiment of the present disclosure. The method provided by the embodiment of the present disclosure may be performed by an on-vehicle device, which may be a navigator, and may be mounted on the second vehicle mentioned in the present embodiment. As shown in FIG. 2, the method may include:

Step 201: displaying icons of respective vehicles in the map according to positions of respective vehicles. More particularly, the on-vehicle device may receive positions of respective vehicles broadcast by each vehicle via V2X communication, and display icons of respective vehicles at positions of respective vehicles in the map.

Step 202: changing colors of the icons of the first vehicle corresponding to the first vehicle in the map when a rescuing request transmitted by the first vehicle is received. More particularly, the on-vehicle device may determine the changed color of the icons of the first vehicle according to the emergency level of rescuing action in the rescuing information carried by the rescuing request. Furthermore, the on-vehicle device may further display the rescuing information carried by the rescuing request. It is possible to enhance the significance in the map by displaying the icons of the first vehicle according to the emergency level of rescuing action. For example, the brighter the color is, the higher the emergency level of rescuing action is, and thus, the more easily the user may notice the icon, and the higher the probability for obtaining a quick rescue.

Furthermore, after the step 202, a rescuing response may be transmitted to the first vehicle, if the rescuing response input by the user on the interface displaying the map is acquired. Furthermore, it may be possible to perform navigation with respect to the rescuing route and display the rescuing route in the map. More particularly, the starting point of the rescuing route may be the position where the second vehicle with the on-vehicle device thereon is located, and the ending point of the rescuing route is where the first vehicle is located.

More particularly, it is possible to improve the rescuing efficiency by automatically performing the navigating of the rescuing route when the on-vehicle device makes the response to the rescuing request.

According to the embodiments of the present disclosure, it is possible to enable the nearby vehicles to provide rescuing in time, improve the efficiency of rescuing and the vehicles to be rescued may acknowledge the positions of the rescuing vehicles by acquiring the rescuing information input by a user on the interface displaying a map, and then generating a rescuing request carrying the rescuing information and further broadcasting the rescuing request via V2X communication and displaying the position of the rescuing vehicle in the map when the rescuing response is received.

### Third Embodiment

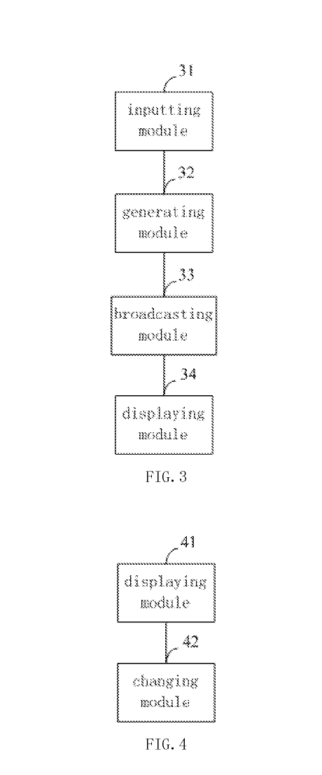

FIG. 3 is a structural view of a device for rescuing vehicles provided by the third embodiment of the present disclosure. The device in the embodiment of the present disclosure may be mounted on the first vehicle mentioned in the present embodiment. As shown in FIG. 3, the device may include: an inputting module 31, a generating module 32, a broadcasting module 33, and a displaying module 34.

The inputting module may be configured to acquire rescuing information for requesting a rescuing for a first vehicle input on an interface displaying a map by a user. In the map, icons of respective vehicles are displayed according to the positions of respective vehicles.

The generating module may be connected with the inputting module 31 and configured to generate a rescuing request. The rescuing request may include a position of the first vehicle and the rescuing information.

The broadcasting module 33 may be connected with the generating module 32 and configured to broadcast the rescuing request via V2X (Vehicle to X) communication. More particularly, the broadcasting module 33 may continuously broadcasting the rescuing request based on V2X communication, until a rescuing response transmitted by a second vehicle is received.

The displaying module 34 may be connected with the broadcasting module 33 and configured to erase the icons of respective vehicles displayed in the map with the on-vehicle device, and display the icons of the first vehicle according to the position of the first vehicle in the map, and display the icons of the second vehicle according to the position of a second vehicle in the map, if a rescuing response transmitted by the second vehicle is received.

More particularly, a driver, as a user, may visibly acknowledge the positions of nearby vehicles by receiving positions of respective vehicles broadcast by each vehicle via V2X communication and displaying icons of respective vehicles at the positions of respective vehicles in the map. This is because the V2X communication is a kind of short-range communication, and thus based on the positions of vehicles, particularly the positions of nearby vehicles, received via V2X communication, and icons of vehicles displayed in the map, the driver may acknowledge positions of nearby vehicles even in a region with a narrow visual field, and the safety in driving may be improved. Meanwhile, a rescuing button may be provided on the interface displaying the map, and when the rescuing button is pressed by the user, rescuing information may be input on the interface. The rescuing information may include one or more of model of vehicle, plate number, name of owner of the vehicle, description on fault, reward, and emergency level of rescuing action, and combinations thereof. For example, the rescuing information may include the number of people to be rescued, fault of vehicle to be rescued, health conditions of people to be rescued, supplies demands, personnel demands, technique demands, service demands, rescuing level, notes, and the like. More particularly, the more emergent the rescuing situation is, the higher the rescuing level is.

According to the embodiments of the present disclosure, it is possible to enable the nearby vehicles to provide rescuing in time, improve the efficiency of rescuing and the vehicles to be rescued may acknowledge the positions of the rescuing vehicles by acquiring the rescuing information input by a user on the interface displaying a map, and then generating a rescuing request carrying the rescuing information and further broadcasting the rescuing request via V2X communication and displaying the position of the rescuing vehicle in the map when the rescuing response is received.

### Fourth Embodiment

FIG. 4 is a structural view of another device for rescuing vehicles provided by the fourth embodiment of the present disclosure. The device may include: a displaying module 41 and a changing module 42.

The displaying module 41 may be configured to display icons of respective vehicles in the map according to positions of respective vehicles. More particularly, the changing module 41 may determine the changed color of the icons of the first vehicle according to the emergency level of rescuing action in the rescuing information carried by the rescuing request. Furthermore, the displaying module 41 may further display the rescuing information carried by the rescuing request. It is possible to enhance the significance in the map by displaying the icons of the first vehicle according to the emergency level of rescuing action. For example, the brighter the color is, the higher the emergency level of rescuing action is, and thus, the more easily the user may notice the icon, and the higher the probability for obtaining a quick rescue.

The changing module 42 may be configured to change colors of the icons of the first vehicle corresponding to the first vehicle in the map when a rescuing request transmitted by the first vehicle is received.

Furthermore, the changing module 42 may be further configured to restore the color of the icons of the first vehicle back to the state before changed when it is detected that the first vehicle stops transmitting the rescuing request.

According to the embodiments of the present disclosure, it is possible to enable the nearby vehicles to provide rescuing in time, improve the efficiency of rescuing and the vehicles to be rescued may acknowledge the positions of the rescuing vehicles by acquiring the rescuing information input by a user on the interface displaying a map, and then generating a rescuing request carrying the rescuing information and further broadcasting the rescuing request via V2X communication and displaying the position of the rescuing vehicle in the map when the rescuing response is received.

### Fifth Embodiment

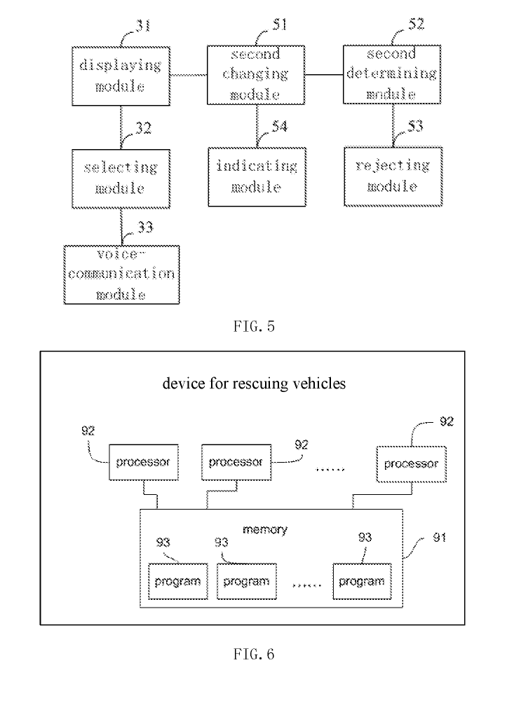

FIG. 5 is a structural view of still another device for rescuing vehicles provided by the third embodiment of the present disclosure. Based on the device for rescuing vehicles provided by the fourth embodiment, in the present embodiment, the device further includes: an inputting module 51, a transmitting module 52, and a navigating module 53.

The inputting module 51 may be configured to acquire a rescuing response input by a user on the interface displaying a map.

The transmitting module 52 may be connected with the inputting module 51 and configured to transmit the rescuing response to the first vehicle.

The navigating module 53 may be connected with the displaying module 41 and the inputting module 51, and configured to perform navigation with respect to the rescuing route. More particularly, the starting point of the rescuing route may be the position where the second vehicle with the on-vehicle device thereon is located, and the ending point of the rescuing route is where the first vehicle is located.

Therefore, the displaying module 41 may be further configured to display the rescuing route in the map.

Furthermore, the device in the present embodiment may further include: a determining module 54 and an extracting module 55.

The determining module 54 may be connected with the displaying module 41 and the changing module 42 and configured to determine the changed color of the icons of the first vehicle according to the emergency level of rescuing action in the rescuing information carried by the rescuing request.

The extracting module 55 may be connected with the changing module 42 and configured to display the rescuing information carried by the rescuing request.

According to the embodiments of the present disclosure, it is possible to enable the nearby vehicles to provide rescuing in time, improve the efficiency of rescuing and the vehicles to be rescued may acknowledge the positions of the rescuing vehicles by acquiring the rescuing information input by a user on the interface displaying a map, and then generating a rescuing request carrying the rescuing information and further broadcasting the rescuing request via V2X communication and displaying the position of the rescuing vehicle in the map when the rescuing response is received.

### Sixth Embodiment

The embodiment of the present disclosure may provide a navigator including the device for rescuing vehicles provided by the foregoing third embodiment or the device for rescuing vehicles provided by the foregoing fourth embodiment, and the device for rescuing vehicles provided by the foregoing fifth embodiment.

More particularly, the navigator may acquire rescuing information input on an interface displaying a map by a user; wherein, in the map, icons of respective vehicles are displayed according to the positions of respective vehicles; generate a rescuing request including a position of the first vehicle carrying the device and the rescuing information; broadcast the rescuing request via V2X (Vehicle to X) communication; erase the icons of respective vehicles displayed in the map and display the icons of the first vehicle according to the position of the first vehicle in the map, and displaying the icons of the second vehicle according to the position of a second vehicle in the map, if a rescuing response transmitted by the second vehicle is received.

More particularly, the on-vehicle device of the navigator may display icons of respective vehicles in the map according to positions of respective vehicles; change colors of the icons of the first vehicle corresponding to the first vehicle in the map when a rescuing request transmitted by the first vehicle is received.

Optionally, the navigator may determine the changed color of the icons of the first vehicle according to the emergency level of rescuing action in the rescuing information carried by the rescuing request and may further display the rescuing information carried by the rescuing request.

Furthermore, as a possible application scenario, the navigator may transmit a rescuing response to the first vehicle when the rescuing response input by the user on the interface displaying the map is acquired. It may be possible to perform navigation with respect to the rescuing route and display the rescuing route in the map. More particularly, the starting point of the rescuing route may be the position where the second vehicle with the on-vehicle device thereon is located, and the ending point of the rescuing route is where the first vehicle is located.

More particularly, as another possible application scenario, when the navigator may not acquire the rescuing response input by the user on the interface displaying the map, the navigator may restore the color of the icons of the first vehicle back to the state before changed when it is detected that the first vehicle stops transmitting the rescuing request.

The hardware structure of the navigator in the present embodiment may include a locating module, a navigator module, and a V2X communication circuit, as well as a touch display. The touch display may display icons of respective vehicles in the map according to positions of respective vehicles. The navigating module may generate a rescuing request carrying rescuing information when the touch display acquires rescuing information input by a user on an interface displaying a map. The V2X communication circuit may further broadcast the rescuing request via V2X communication and the touch display may display the positions of rescuing vehicles in the map when the V2X communication circuit receives the rescuing response, which may enable the nearby vehicles to provide rescuing in time, improve the efficiency of rescuing and the vehicles to be rescued may acknowledge the positions of the rescuing vehicles

According to the embodiments of the present disclosure, it is possible to enable the nearby vehicles to provide rescuing in time, improve the efficiency of rescuing and the vehicles to be rescued may acknowledge the positions of the rescuing vehicles by acquiring the rescuing information input by a user on the interface displaying a map, and then generating a rescuing request carrying the rescuing information and further broadcasting the rescuing request via V2X communication and displaying the position of the rescuing vehicle in the map when the rescuing response is received.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A method for rescuing vehicles, comprising:
acquiring rescuing information for requesting a rescuing for a first vehicle input on an interface displaying a map by a user, wherein, in the map, icons of respective vehicles are displayed according to positions of respective vehicles;
generating a rescuing request, the rescuing request comprising a position of the first vehicle and the rescuing information;
broadcasting the rescuing request via V2X (Vehicle to X) communication; and
erasing icons of respective vehicles displayed in the map and displaying the icons of the first vehicle according to the position of the first vehicle in the map, and displaying the icons of the second vehicle according to the position of a second vehicle in the map, if a rescuing response transmitted by the second vehicle is received.

2. The method for rescuing vehicles according to claim 1, wherein the broadcasting the rescuing request via V2X communication further comprises:
continuously broadcasting the rescuing request based on V2X communication, until a rescuing response transmitted by a second vehicle is received.

3. The method for rescuing vehicles according to claim 1, wherein the rescuing information comprises one or more of model of vehicle, plate number, name of owner of the vehicle, description on fault, reward, and emergency level of rescuing action, and combinations thereof.

4. A method for rescuing vehicles, comprising:
displaying icons of respective vehicles in the map according to positions of respective vehicles; and
changing colors of the icons of the first vehicle corresponding to the first vehicle in the map when a rescuing request transmitted by the first vehicle is received.

5. The method for rescuing vehicles according to claim 4, wherein after the changing colors of the icons of the first vehicle corresponding to the first vehicle in the map, the method further comprises:
acquiring the rescuing response input by the user on the interface for displaying the map; and
transmitting the rescuing response to the first vehicle.

6. The method for rescuing vehicles according to claim 5, wherein after the acquiring the rescuing response input by the user on the interface displaying the map, the method further comprises:
performing navigation with respect to the rescuing route, wherein the starting point of the rescuing route may be the position where the second vehicle with the on-vehicle device thereon is located, and the ending point of the rescuing route is where the first vehicle is located; and
displaying the rescuing route in the map.

7. The method for rescuing vehicles according to claim 4, wherein after the changing colors of the icons of the first vehicle corresponding to the first vehicle in the map, the method further comprises:
restoring the color of the icons of the first vehicle back to the state before changed when it is detected that the first vehicle stops transmitting the rescuing request.

8. The method for rescuing vehicles according to claim 4, wherein after the changing colors of the icons of the first vehicle corresponding to the first vehicle in the map, the method further comprises:
displaying the rescuing information carried by the rescuing request.

9. The method for rescuing vehicles according to claim 4, wherein before the changing colors of the icons of the first vehicle corresponding to the first vehicle in the map, the method further comprises:
determining the changed color of the icons of the first vehicle according to the emergency level of rescuing action in the rescuing information carried by the rescuing request.

10. A device for rescuing vehicles, comprising:
one or more processors;
a memory; and
one or more programs stored in the memory and configured to perform operations when executed by the one or more processors, wherein the operations comprise:
acquiring rescuing information for requesting a rescuing for a first vehicle input on an interface displaying a map by a user, wherein, in the map, icons of respective vehicles are displayed according to positions of respective vehicles;
generating a rescuing request, the rescuing request comprising a position of the first vehicle and the rescuing information;
broadcasting the rescuing request via V2X (Vehicle to X) communication; and
erasing icons of respective vehicles displayed in the map and displaying the icons of the first vehicle according to the position of the first vehicle in the map, and displaying the icons of the second vehicle according to the position of a second vehicle in the map, if a rescuing response transmitted by the second vehicle is received.

11. The device for rescuing vehicles according to claim 10, wherein the broadcasting the rescuing request via V2X communication further comprises:
continuously broadcasting the rescuing request based on V2X communication, until a rescuing response transmitted by a second vehicle is received.

12. A device for rescuing vehicles, which is applied to a vehicle, the device comprising:
one or more processors;
a memory; and
one or more programs stored in the memory and configured to perform operations when executed by the one or more processors, wherein the operations comprise:
displaying icons of respective vehicles in the map according to positions of respective vehicles; and
changing colors of the icons of the first vehicle corresponding to the first vehicle in the map when a rescuing request transmitted by the first vehicle is received.

13. The device for rescuing vehicles according to claim 12, wherein after the changing colors of the icons of the first vehicle corresponding to the first vehicle in the map, the operations further comprise:
acquiring the rescuing response input by the user on the interface for displaying the map; and
transmitting the rescuing response to the first vehicle.

14. The device for rescuing vehicles according to claim 13, wherein after the acquiring the rescuing response input by the user on the interface displaying the map, the operations further comprise:
performing navigation with respect to the rescuing route, wherein the starting point of the rescuing route may be the position where the second vehicle with the on-vehicle device thereon is located, and the ending point of the rescuing route is where the first vehicle is located; and
displaying the rescuing route in the map.

15. The device for rescuing vehicles according to claim 12, wherein after the changing colors of the icons of the first vehicle corresponding to the first vehicle in the map, the operations further comprise:
restoring the color of the icons of the first vehicle back to the state before changed when it is detected that the first vehicle stops transmitting the rescuing request.

16. The device for rescuing vehicles according to claim 12, wherein after the changing colors of the icons of the first vehicle corresponding to the first vehicle in the map, the operations further comprise:
displaying the rescuing information carried by the rescuing request.

17. The device for rescuing vehicles according to claim 12, wherein before the changing colors of the icons of the first vehicle corresponding to the first vehicle in the map, the operations further comprise:
determining the changed color of the icons of the first vehicle according to the emergency level of rescuing action in the rescuing information carried by the rescuing request.
